(19) United States
(12) Patent Application Publication
(10) Pub. No.: US 2026/0279234 A1
(43) Pub. Date: Sep. 17, 2026

(54) DISPLAY DRIVING CHIP WITH BIT ERROR RATE TEST FUNCTION

(71) Applicant: LX SEMICON CO., LTD., Daejeon (KR)

(72) Inventors: Young Bok KIM, Daejeon (KR); Yong Jung KWON, Daejeon (KR); Soo Yeun LEE, Daejeon (KR)

(73) Assignee: LX SEMICON CO., LTD., Daejeon (KR)

(21) Appl. No.: 19/166,151

(22) PCT Filed: Oct. 10, 2023
(86) PCT No.: PCT/KR2023/015533

§ 371 Date: Sep. 17, 2025

(30) Foreign Application Priority Data
Mar. 17, 2023 (KR) 10-2023-0035079

(51) Int. Cl. G09G 3/00; G09G 5/00

(52) U.S. Cl. CPC G09G 3/006; G09G 5/003; G09G 2310/0291; G09G 2330/12

(57) ABSTRACT

A display driving chip with a bit error rate test function that minimizes error rate through test patterns so that high-quality image data may be provided to a display device; and an operation method therefor.

### CROSS-REFERENCE TO RELATED APPLICATIONS

This application is a national phase entry of PCT International Application No. PCT/KR2023/015533 filed on Oct. 10, 2023, which claims the priority of Korean Application No. 10-2023-0035079 filed on Mar. 17, 2023, which are hereby incorporated by reference in their entirety.

### BACKGROUND

### Field of the Disclosure

The present disclosure relates to a configuration which tests a bit error rate using an appropriate test pattern in a display driving chip and reflects the test results in an equalizer circuit, and a circuit operation thereof.

### Description of the Background

The number of display driving chips which transmit image data has also gradually increased in proportion to gradual enlargement of a display screen. In addition, the number of connection lines between the driving chip and a timing controller T-CON is also increasing. The connection lines include a data line traditionally called a bus line or bus, a power line and a ground line for supplying a power voltage, a control line which transmits a clock signal, and the like. An increase in the number of bus lines means that lines of a printed circuit board or flexible board on which the driving chip is mounted become numerous and complex. This not only makes a bezel or mechanism design of a display difficult, but also increases costs. In addition, the number of pins on a semiconductor chip increases, which leads to an increase in chip manufacturing costs. Generally, when the number of pins increases, a price of the semiconductor chip also tends to increase due to an increase in package costs according to an increase in the number of pins. Accordingly, for economic efficiency, a display panel manufacturer always requests semiconductor chip makers to use fewer pins.

FIG. 1 is a view for describing a background of the present disclosure.

Referring to FIG. 1, a display driving chip, specifically, a source driving chip (SDIC) includes an ‘EQ’ pin which is an equalizing pin installed to receive image data transmitted in series from a timing controller 130 at an accurate timing. The EQ pin allows a source driving chip 110 to optimize serial data reception. The optimization includes a bit error rate test (BERT) function so that data bit errors may be detected. The test function is automatically performed by triggering an operation of an equalizer circuit (equalizer) which is present inside the source driving chip 110 through the EQ pin protruding outside the chip. This is called automatic equalization or auto EQ. Among automatic equalization, the equalizing performed before frame data is input or after power-on reset is called ‘initial equalization’.

FIG. 2 is a timing diagram showing automatic equalization.

To better understand a function of the automatic equalization (auto equalizing), the timing diagram shown in FIG. 2 is described as a reference. The automatic equalization is executed before image data for each frame which fills one screen of the display is input. The automatic equalization follows a preset execution operation in the source driving chip 110 which receives data, and is represented as ‘RX Configuration’ in FIG. 2. After the automatic equalization is completed, the source driving chip 110 receives the image data for each frame from the timing controller 130. The data for each frame is composed of first horizontal data 1H Data to nth horizontal data nH Data. A vertical blank V-Blank section is inserted between each frame data. Each of the first to nth horizontal data includes a horizontal blank (H-Blank) section, a section CTR which receives a control signal, and a section which receives the image data as shown in an enlarged view in FIG. 2. For reference, a vertical blank V-Blank means a time for which a scan line moves vertically for a next frame after horizontal scan for one frame is completed when one complete screen is composed of a plurality of frames, and a horizontal blank H-Blank means a time gap between one horizontal scan and the start of a next horizontal scan.

The operating environment may change after the display driving chip starts operating. The changing environment may include, for example, changes in an operating temperature due to heat generated by the display driving chip or timing controller, electromagnetic interference (EMI) due to an operation of other surrounding components, and the like, and these may cause quality deterioration of the transmitted data. Accordingly, a method of minimizing the quality deterioration of the transmitted data is being required.

### SUMMARY

Accordingly, the present disclosure is to provide high-quality image data to a display device using a circuit which automatically optimizes equalization in a display driving chip.

The present disclosure is also to provide an equalizing method optimized to have the lowest error rate in a display driving chip.

According to one aspect of the present disclosure a display driving chip with a bit error rate test function, includes a data receiving unit that receives a test pattern; a clock data recovery unit that recovers an output signal of the data receiving unit according to a clock signal; a data alignment unit that outputs image data; a bit error rate test unit that tests a bit error rate for the recovered data and outputs a result of the test; and an equalization option controller in which an equalization condition is updated when the bit error rate exceeds a preset criterion as the result of the test.

Another aspect of the present disclosure, a display driving chip with a bit error rate test function, includes an equalization option controller that stores conditions of initial equalization; a data receiving unit that receives a test pattern for testing a bit error rate; a clock data recovery unit to which the output of the data receiving unit is transmitted; a data alignment unit that outputs image data; and a bit error rate test unit that extracts the bit error rate as the test pattern is input through the data receiving unit, wherein the initial equalization conditions stored in the equalization option controller are updated and stored based on the extraction result.

There is an effect in that image data provided to a display device may receive a high-quality image without an error by the present disclosure.

There is an effect in that an equalization option in which an error may be minimized without external EQ terminals may be set by the present disclosure, and thus economic efficiency in which terminals of a chip decreases may be promoted.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain the principle of the disclosure.

In the drawings:

FIG. 1 is a view for describing a background of the present disclosure.

FIG. 2 is a timing diagram showing automatic equalization.

FIG. 3 is a block diagram showing the present disclosure.

FIG. 4 is a timing diagram applicable to the present disclosure.

FIG. 5 shows an example of a timing diagram for inter-frame equalization of the present disclosure.

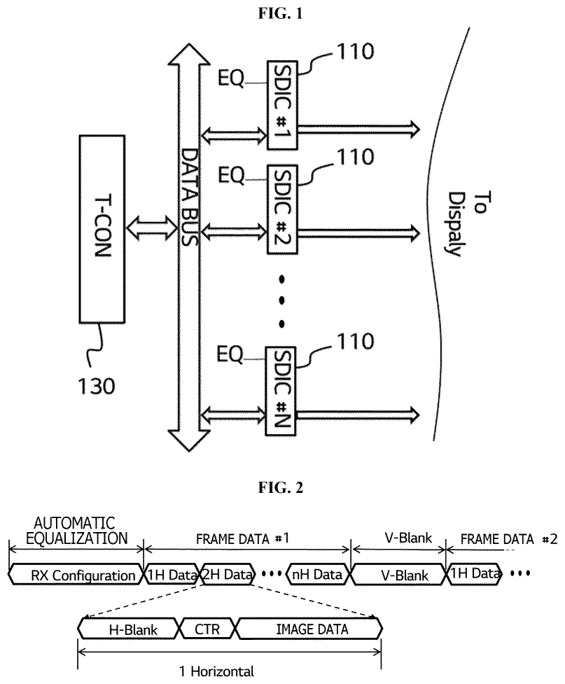

### DETAILED DESCRIPTION

Before describing the present disclosure, a brief description of technical terms and abbreviations frequently used in the present disclosure is provided to help understanding thereof. The technical spirit of the present disclosure may be easily understood by the description. First, throughout the specification of the present disclosure, terms such as a chip, an integrated circuit (IC), a circuit or circuit unit, and a unit may be interchangeably used, and may necessarily mean a configuration which is individually packaged, and that the meaning of these terms should be interpreted based on the description of the technical content. Further, ‘data’ herein means ‘image data’.

A timing controller refers to a semiconductor chip or circuit also called a T-CON, and refers to a configuration which controls transmission of data and data transmission timing so that a display driving chip may appropriately receive image data.

FIG. 3 is a block diagram showing the present disclosure.

A configuration of the present disclosure will be described with reference to FIG. 3.

The timing controller transmits image data to the display driving chip through a data bus. The timing controller and a data transmission unit 210 included therein are not included in the present disclosure, but are shown for convenience of description.

A data receiving unit 220 inside the display driving chip not only may receive data transmitted from the timing controller but also may perform an automatic equalization function, and may include an impedance matching circuit 221 and an equalizer circuit 222.

The impedance matching circuit 221 resolves an impedance mismatch phenomenon between characteristic impedance of the data bus and input impedance of the display driving chip. As a result, distortion of a signal waveform of the transmitted data may be minimized. The impedance matching circuit 221 may be implemented with a combination of passive elements including resistors.

The equalizer circuit 222 is a circuit that overcomes a disadvantage in that binary data which should be distinguished as high and low becomes unclear due to distortion of the signal while the data passes through the data bus at a high speed. A degree of distortion of the signal is usually checked by an eye pattern for binary data. The appropriate equalizing operation by the equalizer circuit 222 improves opening of the eye pattern.

The clock data recovery unit (clock data recovery, CDR) 230 is a circuit which recovers a data signal so that original waveforms of signals output from the data receiving unit 220 may be maintained well or synchronized well with each clock signal. Specially, as a circuit operation becomes gradually faster so that a jitter phenomenon which occurs in various data or control signals is minimized, the data may be accurately synchronized to the clock signal, and thus an operation error is prevented. For convenience of description, the clock signal is not represented separately in the specification of the present disclosure.

A data alignment unit 240 mainly means a circuit configuration also called a deserializer, and realigns the image data synchronized with the clock signal and transmits the image data to a display panel. When the display driving chip transmits the image data, the data alignment unit 240 should sequentially transmit the image data according to scan characteristics of the display panel, and thus deserializes the image data.

The image data transmitted to the display panel through the data alignment unit 240 may be composed of various channels, and in some cases, may be three channel data which represent three primary colors RGB (red, green, and blue) or four channel data of RGBW including white.

In the image data transmitted continuously in real time from the timing controller, the waveform of the signal is distorted or damaged while passing through a long data bus. Even when the data bus is made of a conductive metal material with low resistance, signal distortion caused by signal interference due to parasitic components of the data bus or various noises may not be avoided in a process of transmitting high-frequency image data.

Accordingly, the display driving chip needs to have a function to check whether all the image data has been transmitted perfectly so that an error rate may be reduced even a little. A bit error rate test unit (bit error rate test, BERT) 250 tests whether a bit error occurs in the transmitted image data. The result of the test is provided to an equalization option controller 260. In some cases, the bit error rate test unit 250 may be separately mounted and provided in a test machine which is present separately outside the display driving chip as well as inside the display driving chip, or in a system related to the timing controller. A test pattern for testing the bit error rate may be transmitted from the timing controller which is present separately from the display driving chip or a chip responsible for other processing. In some cases, the bit error rate test unit 250 may generate the test pattern. The test pattern is separate data from the image data and is for testing purposes only.

A pattern named as a pseudo random binary sequence (PRBS) may be used as the test pattern. The PRBS pattern may be represented as a plurality of polynomials, and hardware thereof may be composed of various circuits having a plurality of feedback taps. Since this fact is well known to engineers in this field, detailed description thereof is omitted. A bit error rate test using the PRBS pattern may be pre-emptively executed for each of the clock signal and image data signal.

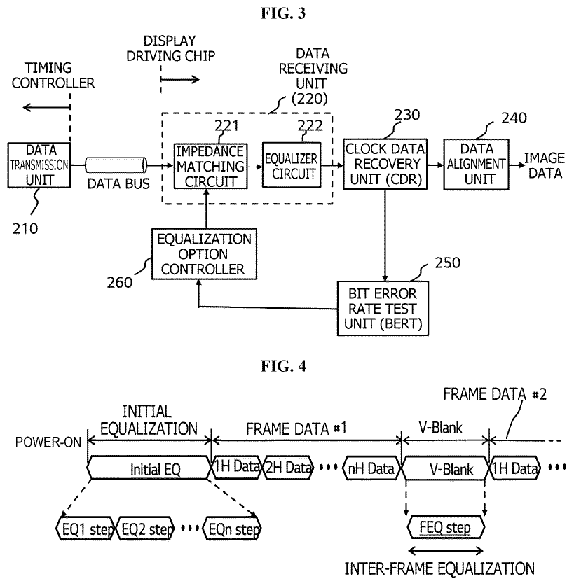

FIG. 4 is a timing diagram applicable to the present disclosure.

Hereinafter, the operation of one aspect of the present disclosure will be described in detail using FIGS. 3 and 4.

A non-driving state is a state in which data processing is not performed immediately after the display driving chip is initialized as a power voltage is applied to the display driving chip or a power on reset (POR) signal is applied to the display driving chip. In this case, initial equalization is performed in the display driving chip based on conditions of the initial equalization predetermined by the timing controller. One of the conditions of the initial equalization may be, for example, the number of equalization steps.

One equalization step refers to one equalizing operation performed in a time interval occupied by one clock or one bit of binary, and the equalizing operation may include a circuit operation of an amplifier in the equalizer circuit 222 utilized to clearly distinguish binary information from a distorted waveform, or a circuit operation of pre-emptively charge-sharing voltages of nodes which should be charged to high or discharged to low in the future to an intermediate value between high and low.

The number or order of the equalization steps is shown in FIG. 4 as ‘an EQ1 step’ to ‘an EQn step’. Another one of the conditions of the initial equalization may be, for example, a voltage gain of the amplifier included in the equalizer circuit 222.

The conditions of the initial equalization may be transmitted from the timing controller or stored in the equalization option controller 260 to be equally performed even during a vertical blank (V-Blank) section. The equalization performed during the vertical blank section is described as “inter-frame equalization” in FIG. 4. The inter-frame equalization is represented as an “FEQ_step” and includes the same number of steps as the number of equalization steps of the initial equalization. The conditions of the initial equalization, for example, the number of equalization steps, may be stored in the equalization option controller 260.

Various types of initial equalization conditions may be stored and changed in the equalization option controller 260. The initial equalization conditions to be stored may be, for example, information related to a gain of the amplifier included in the equalizer circuit 222, the number of equalization steps to be used for the initial equalization or inter-frame equalization, and an allowable bit error rate. The number of equalization steps refers to the number of repetitions of the equalizing operation. The gain of the amplifier may be utilized to minimize waveform distortion due to jitter or to control the degree of eye opening (the opening ratio) so that the degree of eye opening is enlarged by adjusting an output waveform of the amplifier to prevent the output waveform of the amplifier from being excessively overshot or undershot. A change in the equalization step by the equalization option controller 260 may be possible, for example, by changing a value stored in a register or similar device in the equalization option controller 260.

As described above, when the display driving chip starts operating, the operating environment, such as heat generation, noise interference from other chips, and the like changes, and thus quality deterioration of the transmitted data may be caused. Hereinafter, a bit error rate test operation for preventing this will be described.

First, the test pattern for testing the bit error rate, for example, the PRBS pattern as described above is generated in the bit error rate test unit 250 inside the display driving chip or externally and is transmitted to the display driving chip. Since the test pattern is mainly intended to test whether there is an error caused by a transmission path such as a data bus, the test pattern may be transmitted from an external chip of the display driving chip such as the timing controller.

When the test pattern generated by the timing controller passes through the data receiving unit 220 and the clock data recovery unit 230 and reaches the bit error rate test unit 250, the bit error rate test unit 250 determines whether there is an error by extracting information necessary for the test, for example, a bit (an error bit) which represents whether there is an error, from the polynomial which expresses the received test pattern.

Determining whether there is an error is performed by the bit error rate test unit 250, and the result is reflected in the operation of the equalization option controller 260. Whether to reflect is determined by a predetermined error criterion such as an error rate per kilobit, an error rate per megabit, or the like.

Further, it is already well known that a pattern used for error checking, such as the PRBS, may be represented as a plurality of polynomials. Determining whether there is an error may be made, for example, by identifying the changes that occur in the bits which represent the plurality of polynomials change through the bit error rate test unit 250, and recognizing the bits which are different from each other as a result as error bits. The number of error bits extracted from the bits which represent the plurality of polynomials may be represented as a ratio, and thus may be defined as the bit error rate.

When the bit error rate exceeds a predetermined criterion, the operating conditions of the equalizer circuit 222 are changed by the equalization option controller 260. The change in the operating conditions may be an increase or decrease in the number of equalization steps in the inter-frame equalization performed during the vertical blank section.

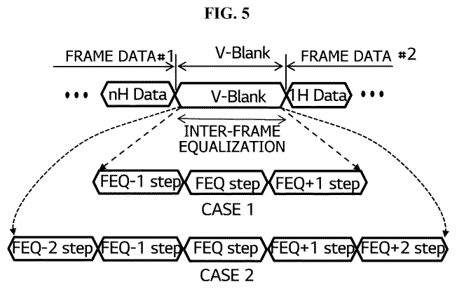

FIG. 5 shows an example timing diagram for the inter-frame equalization of the present disclosure.

Referring to CASE 1 shown in FIG. 5, one equalization step is increased (FEQ+1 step) or decreased (FEQ−1 step) in initially set-up inter-frame equalization (FEQ_step). The increase or decrease in the number of equalization steps may be achieved by updating a value set in the equalization option controller 260 during the initial equalization.

Referring to CASE 2 shown in FIG. 5, after one equalization step is increased or decreased in the inter-frame equalization, when the bit error rate exceeds the predetermined criterion in subsequent inspection of the PRBS test pattern again, the number of equalization steps may be updated again and increased or decreased as described above. The number of additionally increased or decreased equalization steps is disclosed as an FEQ+2 step and an FEQ−2 step in FIG. 5.

Accordingly, the operation of testing the bit error rate using the test pattern and reflecting the bit error rate in the inter-frame equalization may be performed continuously or intermittently during the vertical blank section depending on the error rate.

Hereinafter, another aspect of the bit error rate test will be described.

First, as described above, the conditions of the initial equalization are stored in the equalization option controller 260 and utilized during the inter-frame equalization operation (storing the initial equalization condition).

When a pattern for testing the bit error rate is input, from the inside of the display driving chip or the outside of the display driving chip such as the timing controller, to the bit error rate test unit 250 through the data receiving unit 220 and the clock data recovery unit 230, the bit error rate is primarily extracted. As described above, the extraction of the bit error rate is possible by detecting the error bits related to the PRBS polynomial and comparing the error bits with a preset value (primarily extracting the bit error rate). The preset value may be, for example, a plurality of bits which represent the number or positions of terms in the original polynomial which represents the PRBS pattern.

One example of a comparing operation may be comparing whether the original bits and the bits extracted from the error test unit 250 are the same. A specific comparing operation may be, for example, an operation of comparing the bits which express the original polynomial in the bit error rate test unit 250 with the extracted bits through an exclusive OR (XOR) circuit when the bits which express the original polynomial are stored in a register or similar device. When bits which are not same as each other are found as a result of comparison, the equalization option controller 260 may allow the gain of the amplifiers present in the equalizer circuit 222 to be increased or decreased, or the number of equalization steps to be increased or decreased.

The conditions of the initial equalization stored in the equalization option controller 260 are updated based on the extracted bit error rate. It is natural that the number of equalization steps increased or decreased from the initial equalization is reflected in the updated equalization conditions (updating the equalization conditions).

In the equalizer circuit 222, the inter-frame equalization is performed with the updated equalization conditions (performing the updated equalization).

The above-described bit error rate is repeatedly extracted (secondarily extracting the bit error rate).

Based on the secondarily extracted bit error rate, the equalization option controller 260 does not update the equalization conditions and separately stores new equalization conditions. It is natural that the number of increased or decreased equalization steps is also reflected in the new equalization conditions (storing a plurality of equalization conditions).

The plurality of equalization conditions corresponding to various bit error rates are stored in the equalization option controller 260 by repeating the above-described process, and the equalization condition corresponding to the lowest bit error rate among the bit error rates is selected as an optimal equalization condition (selecting the optimal equalization condition). That is, since the number of equalization steps increased or decreased is automatically determined in inter-frame equalization as the equalization condition which represents the lowest bit error rate is selected, the optimal equalization may be performed during the vertical blank section.

As described above, the conditions of various types of equalization may include not only the number of equalization steps but also the gain of the amplifier included in the equalizer circuit 222. Accordingly, in all aspects of the present disclosure, an increase or decrease in the equalization steps may be replaced with gain adjustment of the amplifier. The gain adjustment may be simply performed by adjusting a value of a passive element which constitutes the amplifier, such as a variable resistor.

In all aspects of the present disclosure, a section in which the display driving chip does not transmit valid data to the display panel is utilized in a series of processes of generating the test pattern, determining a degree of the error, and reflecting this in the equalizing option.

In the present disclosure, the above-described inconveniences are resolved by allowing the display driving chip to be performed an appropriate equalizing operation while the display driving chip is actually used instead of eliminating an external EQ terminal of the display driving chip.

A circuit operation of testing the bit error rate using the PRBS pattern instead of the external EQ terminal, and determining the options of the equalization executed during the section of the initial equalization or automatic equalization by reflecting the test results is disclosed through the aspects.

A display driving chip according to the present disclosure may minimize the deterioration of the quality of transmitted data by preventing the deterioration of the quality of transmitted data when the operating environment is changed after the display driving chip starts operating, and thus may have probability to be effectively utilized in the display field.

It will be apparent to those skilled in the art that various modifications and variations can be made in the present disclosure without departing from the spirit or scope of the aspects of the present disclosure. Thus, it is intended that the present disclosure covers the modifications and variations of the aspects provided they come within the scope of the appended claims and their equivalents.

1. A display driving chip with a bit error rate test function, comprising:
a data receiving unit that receives a test pattern;
a clock data recovery unit that recovers an output signal of the data receiving unit according to a clock signal;
a data alignment unit that aligns data recovered by the clock data recovery unit and outputs the data as image data;
a bit error rate test unit that tests a bit error rate for the data recovered by the clock data recovery unit and outputs a result of the test; and
an equalization option controller that updates an equalization condition when the bit error rate exceeds a preset criterion as the result of the test in the bit error rate test unit.

2. The display driving chip of claim 1, wherein the test pattern is a pseudo random binary sequence (PRBS) pattern.

3. The display driving chip of claim 1, wherein the equalization condition is the number of steps of equalization performed by an equalizer circuit included in the data receiving unit.

4. The display driving chip of claim 1, wherein the equalization condition is a gain of an amplifier included in an equalizer circuit included in the data receiving unit.

5. The display driving chip of claim 1, wherein, in the equalization option controller, conditions of initial equalization input from a timing controller immediately after a power voltage of the display driving chip is applied or immediately after a power-on reset signal is applied are stored.

6. The display driving chip of claim 1, wherein equalization by the update is inter-frame equalization executed in a section between data for each frame.

7. The display driving chip of claim 6, wherein the inter-frame equalization is executed during a vertical blank section between the data for each frame.

8. A display driving chip with a bit error rate test function, comprising:
an equalization option controller that stores conditions of initial equalization;
a data receiving unit that receives a test pattern for testing a bit error rate;
a clock data recovery unit that recovers the test pattern output from the data receiving unit according to a clock signal;
a data alignment unit that aligns the test pattern recovered by the clock data recovery unit and outputs the test pattern as image data; and
a bit error rate test unit that extracts a bit error rate of the test pattern recovered by the clock data recovery unit,
wherein the equalization option controller updates and stores the initial equalization conditions stored in the equalizing operation controller based on an extraction result from the bit error rate test unit.

9. The display driving chip of claim 8, wherein, after the update, the bit error rate is secondarily extracted, and a new equalization condition is separately stored in the equalizing operation controller based on the secondarily extracted result.

10. The display driving chip of claim 9, wherein the equalization option controller stores the new equalization condition based on the secondarily extracted result separately from the updated storage.
